(19) United States
(12) Patent Application Publication
(10) Pub. No.: US 2006/0180094 A1
(43) Pub. Date: Aug. 17, 2006

(54) Pet containment apparatus and method

(76) Inventor: Gregory R. Viggiano, Alexandria, VA (US)

Correspondence Address: SHOEMAKER AND MATTARE, LTD, 10 POST OFFICE ROAD - SUITE 110, SILVER SPRING, MD, 20910, US

(21) Appl. No.: 11/057,137

(22) Filed: Feb. 15, 2005

(51) Int. Cl. A01K 15/04

(52) U.S. Cl. 119/721

(57) ABSTRACT

An electronic containment apparatus for and method of controlling the movement of an animal relative to a protected area employs magnetic fields for designating exclusion or containment areas within a household. The animal is provided with a collar, which includes a magnetic marker designed to perturb a magnetic field produced by an exclusion unit's magnetic field generator. The exclusion unit produces stimuli to which the animal responds, but to which humans do not respond.

### BACKGROUND OF THE INVENTION

Animal stewards often want to confine animals to a particular area without having to erect physical barriers, such as fences. Reasons for controlling animal movement range from protecting furniture to safety concerns, such as protecting the animal from unauthorized exit or accessing cupboards where harmful domestic cleaning products may be stored.

Some stewards bound the area with an electrified perimeter wire that provides sensitivity to the proximity of a collar-mounted device. These systems commonly either contain an animal within a perimeter or take the form of an “electronic tether.” Most often, these animal control systems utilize a bulky radio frequency (RF) receiver attached to an animal's collar to limit the movement of the animal within a designated area. Commonly, the designated area is configured through the placement of a buried wire that transmits a signal produced by a transmitter. The wire and the signal create exclusion areas, or “boundaries,” in which the animal wearing the collar is controlled. Upon approaching an exclusion area, the collar receiver detects the electromagnetic signal and delivers an audible signal or electric shock to the animal. The effect of the repeated stimulus teaches the animal, to avoid the exclusion areas, thus confining the animal without use of fences or gates. See, for example, U.S. Pat. No. 5,787,841, issued Aug. 4, 1998, to J. Titus et al. for an Apparatus And Method For Electronic Exclusion And Confinement Of Animals Relative To A Selected Area. This form of negative reinforcement animal training is offensive to some pet owners and animal trainers because physical pain is used to affect and modify animal behavior.

The foregoing types of animal containment systems are not well suited to indoor use. Adopting an outdoor perimeter system for indoor use would require that a wire be placed around the entire room, which would significantly reduce the area within the room in which the animal may roam without receiving a corrective stimulus.

Variations of this technology are known to keep animals out of small designated areas, such as bedrooms and kitchens and exclude access to front doors and garages. In these applications, an RF transmission station is located in a room or area in which animals are to be excluded. The omni-directional transmission of the RF signal creates a spherical zone of transmission or “exclusion area” in which the attached animal's receiver collar is responsive to the RF signal. Upon entering the designated area, the receiver collar is adapted to detect the RF signal and, in response, deliver a correction stimulus to the animal. Again, the stimulus usually is a painful electric shock.

A problem associated with RF type of confinement systems involves RF interference that permits animals to approach and even pass through the perimeter without receiving an adequate control signal to prevent such movement.

Another problem concerns unintended corrections where an animal occasionally experiences unintended shocks. The constant presence of RF interference increases the chance that unintended shocks may be delivered. Such unintended shocks to the animal can decrease the effectiveness of the RF electronic animal containment systems to control the animal. Such accidental shocks also can lead to undesirable animal behavior.

Other indoor pet control systems exclude animals with ultrasonic transmitters that generate a continuous repulsion signal. The animal is excluded from entering the area simply because the volume of the ultrasonic signal becomes uncomfortably high as the animal draws nearer. Systems of this type suffer from several deficiencies, including a lack of intelligence, so the system cannot distinguish between different animals that may approach the exclusion area. See, for example, U.S. Pat. No. 6,250,255, issued Jun. 26, 2001, to M. L. Lenhardt et al. for Methods And Apparatus For Alerting And/or Repelling Birds And Other Animals. A drawback of these kinds of systems is that, since the ultrasonic signal generally is continuous, the animal is subjected to constant annoyance, even when away from the exclusion area.

Some devices do not subject an animal to electrical stimuli. See, for example, U.S. Pat. No. 5,570,655, issued Nov. 5, 1996, to A. Targa, which describes a Device For Controlling Animal Access To A Location. A magnet mounted on a collar causes reed switches defining an exclusion area to initiate a signal device to produce loud noises.

Except for the continuously-broadcasting system, the foregoing animal containment systems require mounting on the animal a specialized collar that includes an energy-dependent transceiver. While many devices provide for alerting the steward of an inadequate power level for the transceiver, the steward nevertheless is burdened with having to replenish the power supply. Such collars also often are not aesthetically pleasing. What is needed is a pet containment system that relies on a passive, detectable magnetically-responsive marker that does not require a power supply or a specialized collar.

Passive magnetically-responsive marker detection systems exist. See, for example, U.S. Pat. No. 6,734,795, issued May 11, 2004, to W. R. Price for Location Of Lost Dentures Using RF Transponders. A transmitter-detector transceiver emits an excitation field that is detectable by a signaling device, mounted on a denture. See also, for example, U.S. Pat. No. 5,049,856, issued Sep. 17, 1991, to M. D. Crossfield for Antipilferage Systems, wherein a warning signal issues when a magnetic interrogation field interacts with an antipilferage tag.

While the foregoing marker detection systems may provide for issuing warning signals to which humans may respond, none are configured to monitor animal positions and issue stimuli, such as ultrasonic signals, for controlling animals, which humans generally cannot hear.

Unfortunately, none of the foregoing provides a pet containment device that is sensitive to a passive, detectable marker and employs responsive ultrasonic stimuli.

### SUMMARY OF THE INVENTION

The invention overcomes the disadvantages noted above by providing a pet containment device that is sensitive to a passive, detectable marker and employs responsive stimuli to which targeted animals respond, but to which humans do not respond.

To overcome the limitations in the prior art, such as those described above, and to overcome other limitations that will become apparent upon reading and understanding the present specification, the invention is directed to a method and apparatus for controlling the movement of an animal relative to a protected area by using magnetic fields for designating exclusion or containment areas within a household and includes a magnetic field-based pet containment system that uses responsive stimuli to which targeted animals respond, but to which humans do not respond to deter animals from approaching designated household areas.

The invention improves over current animal containment and exclusion systems because it does not require the animal to wear a battery-powered collar for production of behavioral corrective audible signals or electric shock stimuli.

Unlike currently available animal containment devices, the invention uses magnetic fields produced by a small, low-cost magnetic field generator that is not subject to RF interference. The alternating magnetic field is generated by an exclusion unit to designate a protected area in which the animal is to be contained or from which the animal is to be excluded. The coverage area of the magnetic field is adjustable. For extended range or shaping a non-regular perimeter, an optional antenna can be placed under the flooring or carpeting.

A magnetic marker is placed in the animal's collar or otherwise on the animal. The marker includes a body of magnetic material with retained stress and has a magnetic hysteresis loop with a large Barkhausen discontinuity. Exposure of the marker to the external magnetic field, having a field strength in the direction opposing the instantaneous magnetic polarization of the marker that exceeds a predetermined threshold value, causes a regenerative reversal of the magnetic polarization of the marker. Exciting the marker with a low frequency and low field strength, so long as the field strength exceeds the minimum threshold level for the marker, causes a regenerative reversal of magnetic polarity generating a harmonically rich pulse that is readily detected and easily distinguished.

As the animal approaches the magnetic field wearing the marker, the exclusion unit's sensor detects the marker perturbing the field and activates an alarm when a predetermined perturbation to the field is detected. The alarm then activates a stimulus tailored to controlling the animal. The stimulus may be an audible alert and/or an ultrasonic signal audible only to the animal for a pre-programmed duration, volume, and frequency.

An apparatus configured according to principles of the invention includes a magnetic field generator that generates a magnetic field. A signal detector generates a detector signal responsive to a marker signal generated by a marker in response to the magnetic field. A stimulus emitter generates stimuli responsive to the detector signal to which animals respond, but to which humans do not respond. A method configured according to principles of the invention includes generating a magnetic field associated with a protected area; detecting a marker signal emitted by a marker in response to the magnetic field; generating a detector signal in response to the marker signal; and generating an alarm responsive to the detector signal to which animals respond, but to which humans do not respond.

Among the objects of the invention is to provide a pet containment system that excludes animals from entering protected household areas without reliance on battery powered collars for producing painful, electric shocks to correct the animal's behavior or control the animal's movement relative to a protected area.

Another object of the invention is to provide an alternative, painless, low-cost system to allow desired animal behavior modification.

Yet another object of the invention is to provide an easy to operate, self-installed, and simple to understand system that is safe for the animal while providing effective, painless animal behavior modification, and effective animal movement control.

Still another object of the invention is to provide an improved “passive” collar for an animal to wear that does not require expensive batteries or large, bulky, collar-attached electrical control devices.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is an environmental perspective view of an embodiment of a pet containment apparatus configured according to principles of the invention;

FIG. 2 is an environmental perspective view of a marker of the embodiment of FIG. 1 disposed on a pet collar;

FIG. 3 is an exploded perspective view of the marker of FIG. 2;

FIG. 4 is a perspective view of the exclusion unit of FIG. 1;

FIG. 5 is a schematic view of the exclusion unit of FIG. 1;

FIG. 6 is a side elevational view of the magnetic field generating coil of the embodiment of FIG. 1; and

FIG. 7 is a side elevational view of the signal detector coil of the embodiment of FIG. 1.

### DETAILED DESCRIPTION OF THE PREFERRED EMBODIMENTS

The invention is an apparatus for and a method of pet containment that relies on a passive, detectable marker and employs responsive stimuli to which animals respond, but to which humans do not respond. The invention is based on conventional electronic article surveillance technologies, therefore embraces all advances in the arts relevant thereto, the following description serving only for examples for carrying out the invention, and not as definitive, limiting embodiments thereof.

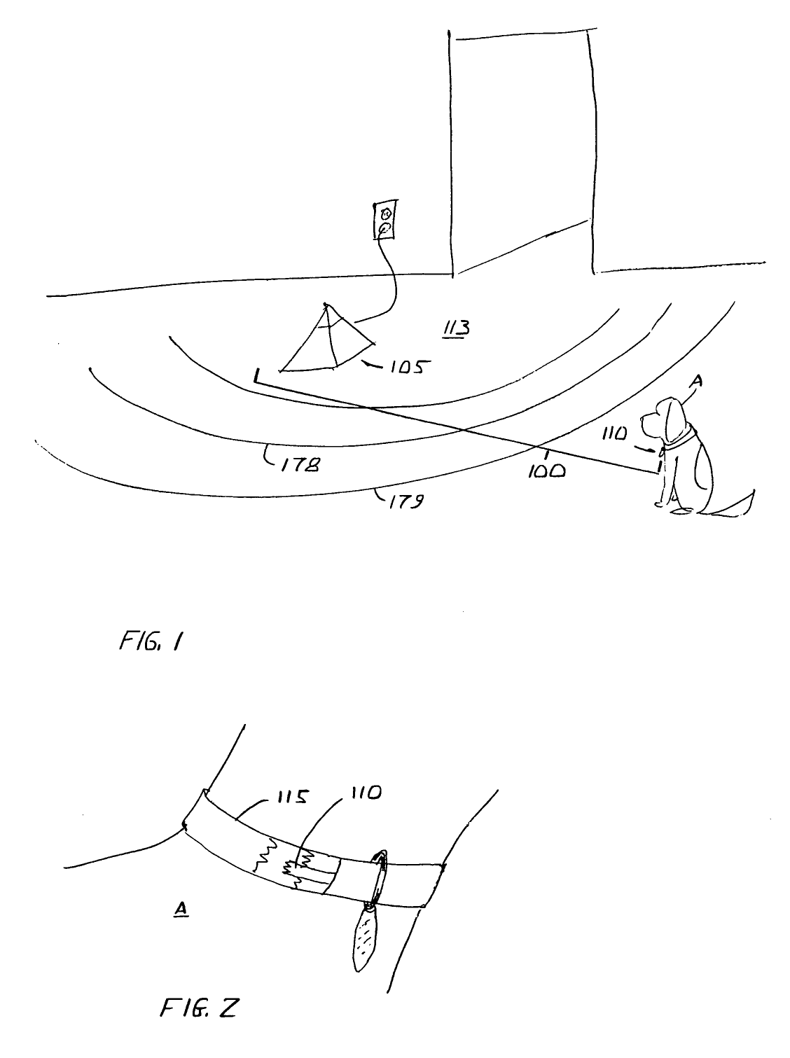

Referring to FIG. 1, an apparatus for pet containment 100 configured according to principles of the invention includes an exclusion unit 105 and a marker 110 attached to one or more animals A to be excluded from a protected area 113. Exclusion unit 105 generates a magnetic field having a predetermined range and configuration that encompasses protected area 113, and detects perturbances in the magnetic field or magnetically-initiated signals emitted by marker 110. Exclusion unit 105 emits stimuli, preferably ultrasonic, in response to detection of magnetic field perturbances or marker signals.

Referring to FIG. 2, preferably, marker 110 is integrated into a collar 115 that readily may be mounted on an animal A. Collar 115 contains no power supply and has no obvious external devices that would distinguish it from any other ordinary pet collar. Alternatively, marker 110 may be attached directly to animal A or collar 115, or embodied in an object, such as a dog tag, that may be attached to collar 115.

Marker 110 may be constructed similarly to markers used in article surveillance systems that employ alternating magnetic fields in an exclusion area. To this end, marker 110 may have a body of magnetic material with retained stress and having a magnetic hysteresis loop with a large Barkhausen discontinuity. Exposure of the marker to the external magnetic field, having a field strength in the direction opposing the instantaneous magnetic polarization of the marker that exceeds a predetermined threshold value, causes a regenerative reversal of the magnetic polarization of the marker. Exciting the marker with a low frequency and low field strength, so long as the field strength exceeds the minimum threshold level for the marker, causes a regenerative reversal of magnetic polarity generating a harmonically rich pulse that is readily detected and easily distinguished.

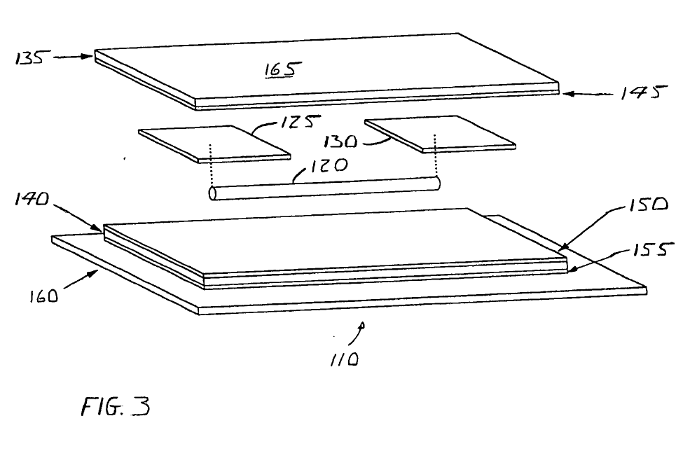

Referring to FIG. 3, an embodiment of marker 110 may include a magnetic wire 120, which acts as a pulse-generating element. Thin magnetic ribbons 125 and 130 are disposed on both ends of wire 120. Wire 120 and ribbons 125, 130 are laminated together between tape bases 135 and 140 having adhesive layers 145, 150 and 155. Disposed on a lower surface (not shown) of base 140 is a release layer 160. Removal of release layer 160 exposes adhesive 155 for adherence to, for example, collar 115. Base 135 has an upper surface 165 that may display indicia, such as pet identification.

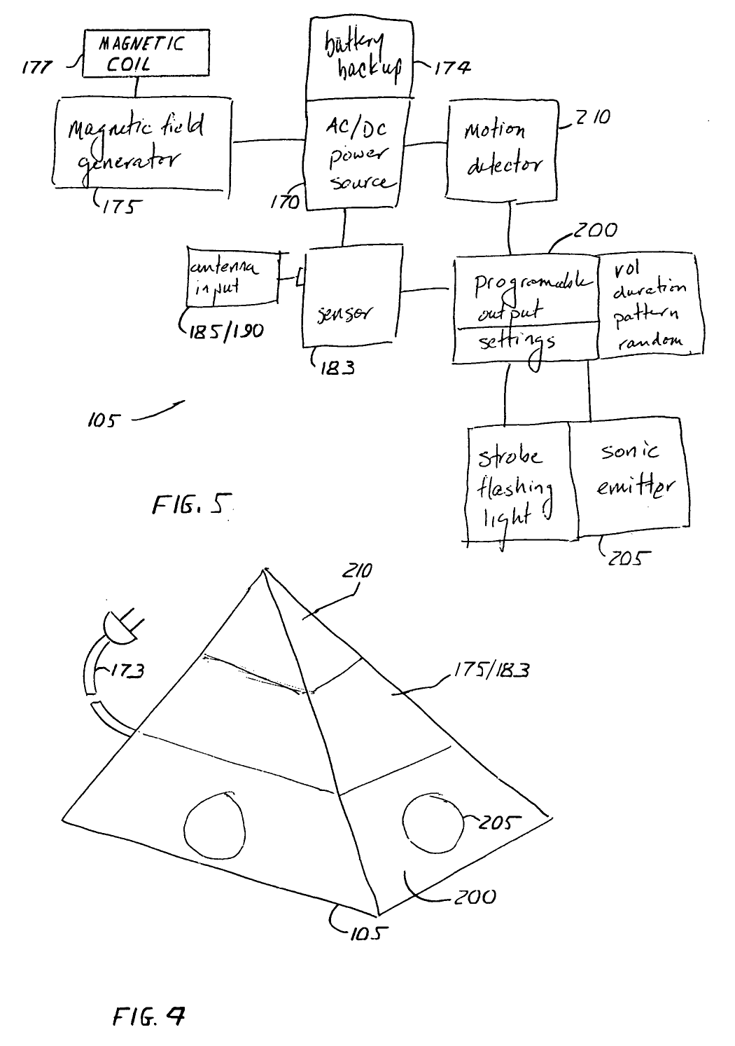

Referring to FIGS. 4 and 5, exclusion unit 105 has a power source 170 with a power cord 173 and operates on AC or DC power. Exclusion unit 105 may have a battery back-up power supply 174 in the event of a power failure.

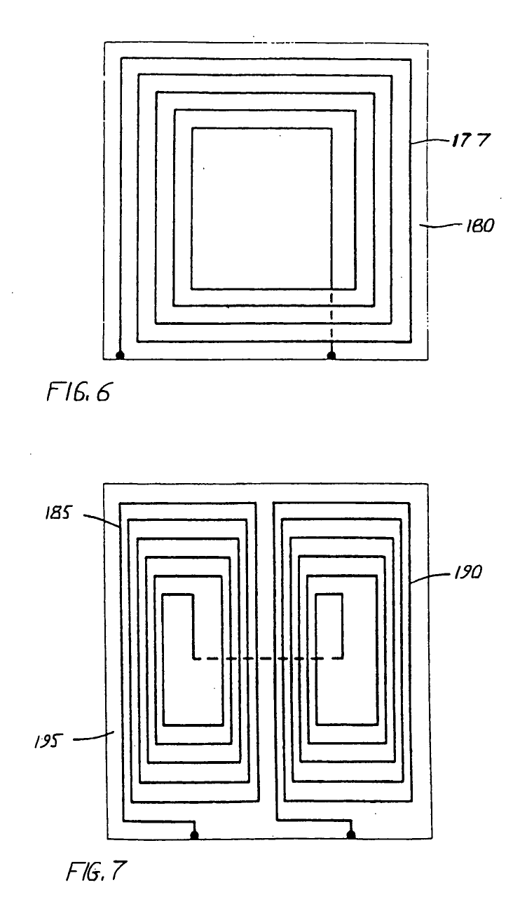

Referring also to FIG. 6, exclusion unit 105 includes a magnetic field generator 175 having a coil 177 for generating a magnetic field (not shown) having a predetermined range. Coil 177 may be disposed directly on a surface of exclusion unit 105 or, preferably, a backing 180 that may be adhered to exclusion unit 105.

Referring also to FIG. 1, magnetic field generator 175 generates a magnetic field having a range that is adjustable to allow for differently sized protection areas 113, such as for restricting access to a front door, a kitchen entrance, a stairway, or a dining room. Magnetic field generator 175 also may generate multiple magnetic fields, defining a primary perimeter 178, a secondary perimeter 179 and other perimeters as needed. For example, secondary perimeter 179 may bound an area that, when an animal enters, exclusion unit 105 responds to same and issues warning level stimuli, such as low volume ultrasonic and/or electromagnetic stimuli, such as light, and the like. Alternatively, primary perimeter 178 and secondary perimeter 179 may be defined within a single magnetic field, but at different field strengths thereof. That is, primary perimeter 178 may exist at the boundary of a magnetic field, where it is weakest, while secondary perimeter 179 may exist where the magnetic field is stronger.

Stimuli having only a warning level may not deter animals from the area bounded by secondary perimeter 179, but would warn the animal that it is approaching primary perimeter 178. When an animal enters primary perimeter 178, exclusion unit 105 responds to same and issues exclusionary level stimuli, such as high-volume ultrasonic stimuli and/or high-level electromagnetic stimuli and the like.

The magnetic field(s) also may be “shaped” by a floor antenna(e) that lays flat under the flooring or carpeted area. Using an exclusion unit equipped with a antenna would be suitable to protect a dining room table, houseplant, Christmas tree, or other irregular area.

Magnetic field generator 175 may include rotating magnetic field generating circuitry with a driver for driving a plurality of coils 177 at a desired power level and frequency. The driver may energize the coils at a frequency, which may be sized relative to the wavelength, so that the rotating magnetic field generated has substantially no electric field. The rotating magnetic field radiates outwardly to define exclusion area 113 as desired. The magnetic field penetrates common building materials and other impediments that could greatly effect an electromagnetic or RF field. Because magnetic fields decrease in intensity relatively quickly, magnetic fields are well suited to sharply define an exclusion area.

The rotating magnetic field may be circularly polarized to provide a generally circular exclusion area. Elliptical or other polarizations could also be used to define different shapes for the desired exclusion area.

Referring to FIGS. 4, 5, and 7, exclusion unit 105 includes a signal detector 183 having coils 185 and 190 for detecting perturbances or marker signals emitted by marker 110 in response to a magnetic field. Coils 185 and 190 also may be disposed directly on a surface of exclusion unit 105 or, preferably, a backing 195 that may be adhered to exclusion unit 105. For reduced cost and manufacturing simplicity, coil 177 may be disposed on one side of backing 180 and coils 185 and 190 may be disposed on the other side of backing 180. Signal detector 183 processes signals from coils 185 and 190 and generates a detector signal when a perturbance or marker signal corresponds to very high order harmonics of the applied field.

Referring to FIGS. 4 and 5, exclusion unit 105 includes an alarm unit 200 that is responsive to signal detector 183. Alarm unit 200 drives stimuli emitters 205 that are responsive to the detector signal generated in response to a marker signal generated by marker 105 responsive to a magnetic field. Stimuli are tailored to a particular animal's sensitivity. The stimuli also are tailored to avoid human sensitivity, therefore only animals are controlled with apparatus 100. Other stimuli include electromagnetic, vibration or other appropriate stimuli.

Preferably, the level of the stimuli, such as the volume of the ultrasonic stimuli, increases as an animal wearing marker 110 draws closer to exclusion unit 105. The stimuli pattern also may change to discourage the animal from becoming accustomed to the signal over time. Stimuli variables, such as intensity level, pattern, duration, and coverage area, to suit specific situations. Exclusion unit 105 may be programmed so that the stimuli variables change randomly.

Referring again to FIGS. 4 and 5, exclusion unit 105 may include a motion detector 210. Motion detector 210 may be tuned to ascertain whether an animal has moved to a quiet retreat area. Thus, after signal detector 183 drives stimulus emitter 205 to emit stimuli, motion detector 210 determines whether the animal has retreated from protected zone 113, then cancels emission of the stimuli.

The invention may be employed to activate devices such as entry/exit pet doors, feeding dispensers, and so forth.

The invention is not limited to the particular embodiments described herein, rather only to the following claims.

I claim:

1. Apparatus for containing an animal comprising:
a magnetic field generator configured to generate a magnetic field;
a signal detector configured to generate a detector signal responsive to a marker signal generated by a marker in response to the magnetic field; and
a stimulus emitter configured to generate a stimulus responsive to said detector signal to which a predetermined animal responds, but to which predetermined humans do not respond.

2. Apparatus of claim 1, further comprising a marker configured to attach to the animal that is responsive to said magnetic field.

3. Apparatus of claim 1, wherein said stimulus is ultrasonic, electromagnetic or combinations thereof.

4. Apparatus of claim 1, further comprising a motion detector configured to detect motion and generate a motion signal responsive thereto;
wherein said stimulus emitter is configured to generate stimulus responsive to said motion signal.

5. Apparatus of claim 4, wherein a signal range within which said signal detector responds to the marker signal differs from a motion range within which said motion detector responds to motion.

6. Apparatus of claim 1, further comprising a primary power supply energized by conventional household electrical service and a secondary power supply that supplies power when said primary power supply fails.

7. Apparatus of claim 1, wherein:
the detector signal exhibits characteristics corresponding to strength of the magnetic field; and
said stimulus emitter generates said stimulus at levels corresponding to the characteristics.

8. Apparatus of claim 1, wherein:
said magnetic field generator is configured to generate a second magnetic field; and
said signal detector is configured to generate a second detector signal responsive to a second marker signal generated by a marker in response to the second magnetic field.

9. Apparatus of claim 8, wherein said stimulus emitter generates said stimulus at a first level responsive to said detector signal and said stimulus emitter generates said stimulus at a second level responsive to said second detector signal.

10. Method of containing an animal relative to a protected area comprising:
generating a magnetic field associated with the protected area;
detecting a marker signal emitted by a marker in response to the magnetic field;
generating a detector signal in response to the marker signal; and
generating stimulus responsive to the detector signal to which a predetermined animal responds, but to which predetermined humans do not respond.

11. Method of claim 10, further comprising providing on an animal a marker configured to respond to the magnetic field.

12. Method of claim 10, wherein the stimulus comprises ultrasonic stimuli, electromagnetic stimuli or combinations thereof.

13. Method of claim 10, further comprising:
detecting motion relative to the protected area;
generating a motion signal responsive to the motion; and
generating stimulus responsive to the motion signal.

14. Method of claim 13, wherein a signal range within which said detecting a marker signal occurs differs from a motion range within which said detecting motion occurs.

15. Method of claim 10 wherein:
the detector signal exhibits characteristics corresponding to strength of the magnetic field; and
said stimulus emitter generates stimulus at levels corresponding to the characteristics.

16. Method of claim 10, further comprising:
generating a second magnetic field associated with the protected area;
detecting a second marker signal emitted by the marker in response to the second magnetic field;
generating a second detector signal in response to the second marker signal; and
generating a second stimulus responsive to the second detector signal.

17. Method of claim 16, wherein the stimulus has a first level and the second stimulus has a second level.
